(19) United States
(12) Patent Application Publication
(10) Pub. No.: US 2023/0279520 A1
(43) Pub. Date: Sep. 7, 2023

(54) Hydrometallurgical Processes For Battery Recycling

(71) Applicant: The Doe Run Resources Corporation, St. Louis, MO (US)

(72) Inventors: Timothy Roy HYMER, Labadie, MO (US); Bennson Chemuta TANDA, Rolla, MO (US); Jackson Curtis RILEY, Rolla, MO (US); John Lawrence UHRIE, Rolla, MO (US); Anthony Kenneth STALEY, Rolla, MO (US); Scott Paul HOENECKE, Rolla, MO (US)

(21) Appl. No.: 18/115,373

(22) Filed: Feb. 28, 2023

Related U.S. Application Data
(60) Provisional application No. 63/314,838, filed on Feb. 28, 2022.

(51) Int. Cl. C22B 3/00; H01M 10/54; C22B 7/00; C22B 30/02; C22B 13/02

(52) U.S. Cl. CPC C22B 13/045; C22B 7/001; C22B 7/007; C22B 13/025; C22B 30/02; H01M 10/54

(57) ABSTRACT

A method of recovering lead, antimony tin from lead acid batteries, lead bearing scrap and other lead bearing materials which includes smelting lead bearing materials in a reverb furnace to recover metallic lead; leaching the resultant slag produced in the reverb furnace with ammonium chloride (NH₄Cl) to produce a slurry; precipitating antimony from the slurry with ferric chloride (FeCl₃); performing a solid-liquid separation of the slag away from the resulting pregnant leach solution; precipitating lead carbonate (PbCO₃) from the pregnant leach solution with carbon dioxide (CO₂); recovering the precipitated lead carbonate (PbCO₃) through solid-liquid separation; and processing the precipitated lead carbonate (PbCO₃) in a reverb furnace to recover metallic lead.

### FIELD

This disclosure relates to the recycling of lead acid batteries and other lead bearing materials, and in particular to a hydrometallurgical process for the recovery of lead, and potentially other metals such as tin and antimony from slag from a reverberatory furnace used to recycle batteries.

### BACKGROUND

This section provides background information related to the present disclosure which is not necessarily prior art.

One common method for recycling lead acid batteries is to smelt lead-containing battery materials in a reverberatory furnace to produce “soft” or “corroding grade” lead. A by-product of this process is a slag, which often contains appreciable amounts of lead and other valuable metals such as antimony and tin. This slag is typically processed through another energy intensive pyrometallurgical process such as in a rotary furnace or a blast furnace to generate additional salable lead products. This lead also contains most of the antimony and tin and is referred to as “hard” lead.

### SUMMARY

This section provides a general summary of the disclosure, and is not a comprehensive disclosure of its full scope or all of its features.

Embodiments of this disclosure provide methods of recovering lead, antimony and tin from lead acid batteries and/or other lead bearing materials. According to one preferred embodiment, the method can comprise heating lead bearing materials in a reverberatory furnace to recover metallic lead, and produce a slag. This slag is then crushed and in a leaching process slurried in ammonium chloride (NH₄Cl) solution, preferably at a temperature of between 50° C. and 90° C. and preferably at a pH of between 5 and 7.5: any leached antimony can be precipitated from solution with ferric chloride (FeCl₃) to improve antimony recovery.

The resulting pregnant leach solution is separated from the slurry through any of a number of different methods potentially including settling, filtration, thickening, etc. The remaining solids still contain significant lead, tin and antimony can be further processed to produce salable lead, tin and antimony. Lead carbonate (PbCO₃) is precipitated from the pregnant leach solution, for example with carbon dioxide (CO₂), and the resultant lead carbonate (PbCO₃) may be separated from the leach solution using any of a number of different methods potentially including settling, filtration, thickening, etc. and then sent to the reverberatory furnace to recover metallic lead. Alternatively, the PbCO₃ can be sent to a separate furnace for recovery of high purity (99.99%) lead, which has been unachievable using existing conventional secondary battery processing. At least some of the liquid remaining after the separation of the precipitated lead carbonate (PbCO₃) can be reused in the leaching step.

The leaching is preferably conducted at a pH of between about 5.5 and about 7, and more preferably it is conducted at a pH of between about 6 and about 6.8. The leaching is preferably conducted at a temperature of between about 50° C. and about 90° C., and more preferably it is conducted at a temperature of between about 70° C. - 85° C., and most preferably at about 80° C. The concentration of ammonium chloride (NH₄Cl) during the leaching step is preferably between about 300 g/L and about 380 g/L, and more preferably between 330 g/L and 360 g/L. The solids content of the slurry is preferably between about 3% and about 8%, and more preferably between about 4% and about 6%. The percent solids varies depending upon Pb tenor in the feed and chloride content to achieve high Pb extraction. As the Pb tenor increases, the percent solids decreases. The process can work outside these preferred ranges, but the efficiency may be impacted.

The precipitation of lead carbonate is preferably conducted at a temperature of between about 40° C. and about 70° C., and more preferably at a temperature between about 50° C. and 60° C. The precipitated lead carbonate (PbCO₃) is subjected to a solid-liquid separation prior to processing in the reverberatory furnace.

The separation of the pregnant leach solution from the slurry is preferably accomplished using a slurry thickener where the thickener overflow is part of the pregnant leach solution, and wherein the thickener underflow is subjected to filtering and the resulting filtrate is also part of the pregnant leach solution.

Further areas of applicability will become apparent from the description provided herein. The description and specific examples in this summary are intended for purposes of illustration only and are not intended to limit the scope of the present disclosure.

### DRAWING

The drawing described herein is for illustrative purposes only of selected embodiments and not all possible implementations, and is not intended to limit the scope of the present disclosure.

FIG. 1 is a flow chart of a preferred embodiment of a hydrometallurgical process for recovering lead and other metals from slag from a reverberatory furnace, useful in the recycling of waste batteries.

Corresponding reference numerals indicate corresponding parts throughout the several views of the drawings.

### DETAILED DESCRIPTION

Example embodiments will now be described more fully with reference to the accompanying drawings.

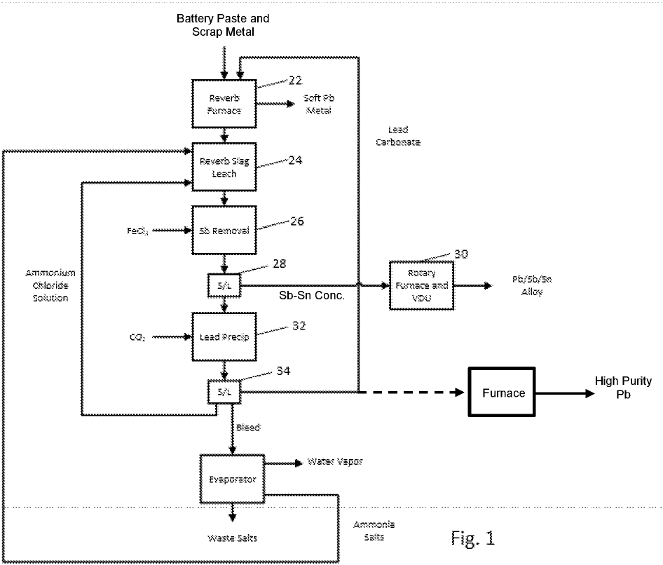

A preferred embodiment of a hydrometallurgical process for recovering lead and other metals from slag from a reverberatory furnace used to recycle waste batteries and other lead bearing materials is indicated generally as 20 in FIG. 1. Although useful in recovering lead and other metals from a variety of sources, the preferred embodiment is described in connection with the recovery of metals in a lead acid battery recycling process.

The paste and metal from the lead acid battery is recovered, for example by crushing the waste batteries and separating the various components, including the battery paste and metal which, as shown at step 22 in FIG. 1, is provided to a reverberatory furnace, which results in the separation of soft lead metal, and the production of a metal-bearing slag. Antimony and tin, which are common alloying elements in the lead in lead acid batteries, report to the slag. When this slag is leached, as described below, the antimony and/or tin are concentrated, and can be further processed into a concentrate so that these metals can be recovered.

At step 24, this slag is preferably water granulated and milled to produce a slurry of between about 3% and about 8%, and more preferably between about 4% and about 6%, solids. (Instead of water granulation, the slag could be crushed and milled). This slurry is subjected to an ammonium chloride (NH₄Cl) leaching process to extract at least lead from the slag. The leaching is preferably conducted at a pH of between about 5.5 and about 7, and more preferably it is conducted at a pH of between about 6 and about 6.8. The leaching is preferably conducted at a temperature of between about 50° C. and about 90° C., and more preferably it is conducted at a temperature of between about 75 - 85° C., and most preferably it is conducted at about 80° C. The concentration of ammonium chloride (NH₄Cl) during the leaching step is preferably between about 300 g/L and about 380 g/L, and more preferably between 330 g/L and 360 g/L.

In this preferred embodiment the slurry will cascade through four leach tanks with a combined residence time of three hours that is achieved in three of the four tanks. In the last tank, at step 26, ferric chloride (FeCl₃) may be added to precipitate any antimony leached into solution.

At step 28, the slurry discharges into a leach discharge thickener where the thickener overflow advances to a pregnant leach solution (PLS) tank and the thickener underflow is pumped to a leach filter-feed tank. The thickened slurry is pumped to a filter press. The filtrate reports to the PLS tank and the filter cake containing valuable lead, tin and antimony is stockpiled for further treatment. For example, at OPTIONAL step 30, the filter cake could be processed with a rotary furnace to generate a lead-tin-antimony bullion which can be further refined through a vacuum distillation furnace (VDU).

At step 32, lead is recovered from solution as lead carbonate precipitate. The PLS preferably advances through a heat exchanger to lower the temperature to about 55° C. for the lead carbonate precipitation process. The precipitation process of step 32 preferably takes place at least partially in two agitated reactors in series where carbon dioxide (CO₂) gas is introduced. This can be done under pressure or at atmospheric pressure, and preferably at a pH of between about 6.0 and about 7.5, and more preferably between about 6.5 and 7.0. At step 34, the precipitate discharges from the reactors and into a precipitation thickener where the precipitate settles. The remaining underflow discharges into a precipitation filter feed tank and is then pumped to a precipitation filter press for dewatering. The lead carbonate filter cake from the precipitate filter is recycled back to the reverberatory furnace. Alternatively, the lead carbonate filter cake can be processed in a separate furnace for the production of high purity (99.99%) lead.

The thickener overflow and filter filtrate are collected in the thickener overflow tank. The liquor is pumped through a multi-media filter to remove suspended solids and discharges into a precipitation barren solution tank. The barren solution is recycled back to leach tanks, and at step 36 a bleed stream reports to an ammonium chloride recovery circuit.

Embodiments of this disclosure allow for the recovery of lead and other metals such as antimony and tin from lead bearing materials such as waste lead acid batteries. These embodiments employ various hydrometallurgical processes, reducing or eliminating the reliance on pyrometallurgical processing with substantial reduction of energy consumption and reduced environmental impact including reduced carbon emissions. The lead from some of the embodiments of this disclosure can be made in high purity (>99.99%).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of recovering lead and antimony from battery paste, metal scrap, and other lead bearing materials, the method comprising:
smelting the lead bearing materials in a reverb furnace to recover metallic lead;
leaching the resultant reverb slag with ammonium chloride solution (NH₄CI) at a temperature of between 50° C. and 90° C. and a pH of between 5 and 7.5;
precipitating antimony from the slurry;
separating a pregnant leach solution from the slurry;
precipitating lead carbonate (PbCO₃) from the pregnant leach solution with carbon dioxide (CO₂);
separating the precipitated lead carbonate (PbCO₃); and
processing the precipitated lead carbonate (PbCO₃) to recover metallic lead.

2. The method according to claim 1 wherein the antimony is precipitated from the slurry with ferric chloride (FeCl₃).

3. The method according to claim 2 wherein the leaching step is conducted at a pH of between 5.5 and 7.

4. The method according to claim 3 wherein the leaching step is conducted at a pH of between 6 and 6.8.

5. The method according to claim 2 wherein the step of precipitating lead carbonate (PbCO₃) is conducted at a temperature of between 40° C. and 70° C.

6. The method according to claim 2 wherein the step of precipitating lead carbonate (PbCO₃) is conducted at a temperature of between 50° C. and 60° C.

7. The method according to claim 2 wherein the precipitated lead carbonate (PbCO₃) is dewatered prior to processing in a reverb furnace.

8. The method according to claim 2 wherein the concentration of ammonium chloride (NH₄CI) during the leaching step is between 300 g/L and 380 g/L.

9. The method according to claim 8 wherein the concentration of ammonium chloride (NH₄CI) during the leaching step is between 330 g/L and 360 g/L.

10. The method according to claim 8 wherein the solids concentration during the leaching step is between 3 % and 8 %.

11. The method according to claim 10 wherein the solids concentration during the leaching step is between 4 % and 6 %.

12. The method according to claim 2 wherein the step of separating a pregnant leach solution from the slurry comprises processing the slurry thickener where the thickener overflow is part of the pregnant leach solution, and wherein the thickener underflow is subjected to filtering and the resulting filtrate is also part of the pregnant leach solution.

13. The method according to claim 2 wherein at least some of the liquid remaining after the separation of the precipitated lead carbonate (PbCO₃) is reused in the leaching step.

14. The method according to claim 13 wherein at least some of the liquid remaining after the separation of the precipitated lead carbonate (PbCO₃) is ammonium chloride (NH₄Cl).

15. The method according to claim 2 wherein the processing of the precipitated lead carbonate (PbCO₃) is done in the same reverbatory furnace with the battery paste and scrap metal.

16. The method according to claim 2 wherein the processing of the precipitated lead carbonate (PbCO₃) is done in a separate furnace to recover high purity lead.
